(19) United States
(12) Patent Application Publication
(10) Pub. No.: US 2016/0044863 A1
(43) Pub. Date: Feb. 18, 2016

(54) LOW CLEARANCE ROW CROP APPLICATION SYSTEM

(71) Applicants: James R. Williams, Clarion, IA (US); Newton Lingenfelter, Clarion, IA (US); Matthew W. Dames, Clarion, IA (US)

(72) Inventors: James R. Williams, Clarion, IA (US); Newton Lingenfelter, Clarion, IA (US); Matthew W. Dames, Clarion, IA (US)

(73) Assignee: HAGIE MANUFACTURING COMPANY, Clarion, IA (US)

(21) Appl. No.: 14/458,967

(22) Filed: Aug. 13, 2014

(51) Int. Cl. A01C 23/02

(52) U.S. Cl. CPC A01C 23/023

(57) ABSTRACT

For low height row crops, the system is a toolbar provided with a plurality of depending legs coupled to discs. Provided behind the discs are nitrogen dispensing systems coupled to a large fluid tank provided on a vehicle. By using medium height legs, the system is able to provide material to the soil after crops have emerged, while still allowing a large number of rows of crops to be treated with each application pass.

### TECHNICAL FIELD

The disclosed embodiments relate generally to a system for applying fertilizer to row crops and, in particular, to a system for applying fertilizer to multiple rows of row crops without irreparably damaging the crops.

### BACKGROUND

Systems for applying nitrogen to row crops are known in the art. Such systems typically involve a tractor pulling a toolbar. The toolbar is provided with a plurality of discs to cut several troughs in the soil. A small trailer, provided with a gas-tight tank, trails behind the toolbar and is provided with hosing to direct anhydrous ammonia or other material from within the tank to the toolbar and then to knives traveling behind the discs.

In this manner, anhydrous ammonia is directed into the troughs below the surface of the soil to increase the nitrogen content thereof. Application of nitrogen in this manner greatly increases the yield of grasses, such as corn. Although grasses continue to obtain benefit from subsequent nitrogen application, tractors and toolbars typically have clearances too low to apply nitrogen to the soil after the plants have started to grow. Application of anhydrous ammonia with a tractor after the plants have emerged from the soil would lead not only to the wide track of the tractor crushing and destroying plants, but would also lead to the low clearance of the toolbar snapping off and killing young plants.

Although it is known in the art to provide high clearance applicators to spray pesticides on growing crops, the high clearance of such applicators typically limits their ability to apply fertilizer directly to the soil. It is also known to provide a system such as that described in U.S. Pat. No. 7,077,070 to provide a system for applying fertilizer to the soil in fields of growing plants one meter or more in height using a plurality of long legs depending from a frame of a toolbar. While such devices allow nitrogen application below the soil in fields with row crops one meter or more in height, the weight of such long legs depending from the toolbar adds additional weight and cost to the toolbar. It would, therefore, be desirable to provide a system for applying fertilizer to growing plants one meter or less in height that allowed for a large number of light legs to depend from a toolbar to allow nitrogen application to a large number of rows of row crops in a single pass. The prior art difficulties described herein above are substantially eliminated by the present invention.

### SUMMARY OF THE DISCLOSED SUBJECT MATTER

The deficiencies described above are overcome by the disclosed implementation of a system for applying fluid below a surface of soil. The system has a plurality of legs depending from a frame. Coupled to the legs are discs and underground fluid dispensers. The frame and legs define areas sufficient to accommodate the unmolested passage of plants between at least approximately 0.5 and no more than approximately 1.5 meters in height.

Other implementations of fluid application systems are disclosed, including implementations directed to systems having more than twenty depending legs.

### BRIEF DESCRIPTION OF THE DRAWINGS

The present invention will now be described, by way of example, with reference to the accompanying drawings in which:

FIG. 1 illustrates a perspective view of the fluid application system in accordance with one embodiment

FIG. 2 illustrates a side elevation of the fluid application system of FIG. 1, shown with the boom folded into the transport position;

FIG. 3 illustrates a top elevation of the boom of FIG. 1;

FIG. 4 illustrates a top elevation of the boom of FIG. 1, shown with the boom folded into the transport position;

FIG. 5 illustrates a front elevation of the boom of FIG. 1, shown with the boom folded into the transport position; and

FIG. 6 illustrates a side elevation of the injection assembly of FIG. 1.

### DETAILED DESCRIPTION OF THE DRAWINGS

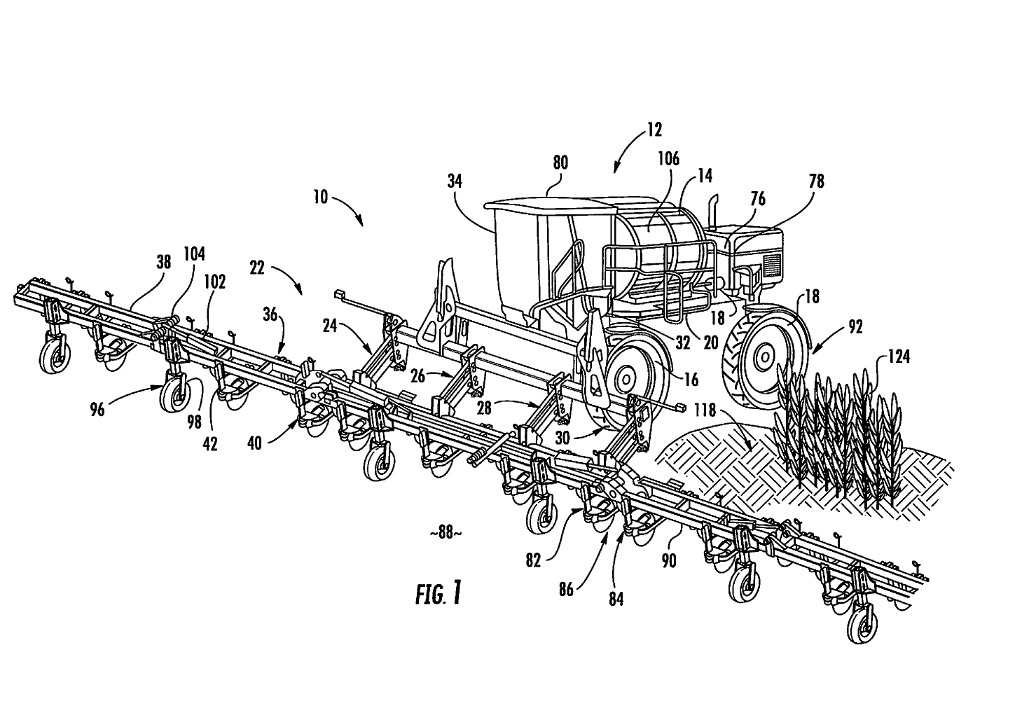

With reference to the drawing, a fluid application system is shown generally as (10) in FIG. 1. The fluid application system (10) is provided with a vehicle (12). While the vehicle (12) may be of any type known in the art, in the preferred embodiment the vehicle (12) is an STS 12 Sprayer manufactured by Hagie Manufacturing Company, Clarion Iowa. The vehicle (12) is preferably provided with a fluid tank (14), preferably gas-tight, having a capacity preferably between 100 and 10,000 gallons, more preferably between 500 and 5,000 gallons, and most preferably between 1,000 and 1,800 gallons. The vehicle (12) is also preferably provided with tires (16) such as 320 90R50, 380 85R46, or 580 70R38 tires, depending on wheel width and soil conditions. The vehicle (12) is provided with a clearance equal to at least about 1 meter. In a preferred embodiment, the vehicle is provided with at least a clearance of approximately 1.8 meters.

The vehicle (12) is also provided with a hydraulic motor (18), coupled by a plurality of hydraulic lines (20) to a hydraulically actuated toolbar (22). The toolbar (22) includes four four bar parallel linkage assemblies (24, 26, 28, and 30) such as those known in the art, to maintain the orientation of the toolbar (22) relative to the vehicle (12), as the toolbar (22) is raised and lowered.

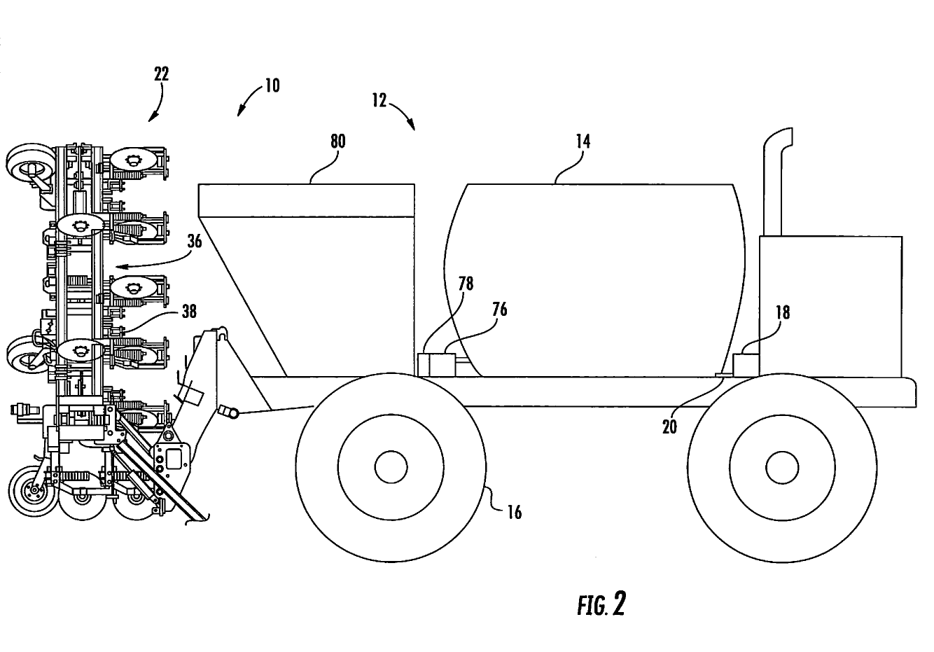

As shown in FIG. 2, the toolbar (22) includes a frame (36) constructed of seven separate bars (38). The bars (38) are hinged to one another and hydraulically actuated to extend as shown in FIG. 1, or to retract, as shown in FIG. 2, for transport. In the preferred embodiment, the toolbar (22) extends from a transport position 3.7 meters wide to a working position 17.5 meters wide.

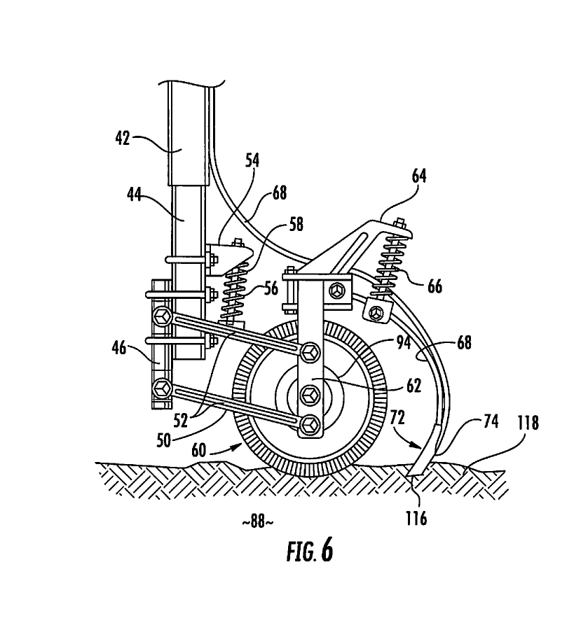

As shown in FIG. 1, bolted to the frame (36) are a plurality of legs (40). As the construction of the legs (40) is substantially similar, the description will be limited to a single leg (42). The leg (42) is a metal tube 10 centimeters wide by 10 centimeters deep, and having a thickness of 0.455 centimeters. Of course it will be obvious to one of ordinary skill in the art, that legs of any suitable construction or dimensions may be used. Coupled to a bottom section (44) of the leg (42) is a stainless steel tube (46). (FIG. 6). The tube (46) is preferably 3.8 centimeters in diameter.

As shown in FIG. 6, the tube (46) forms one bar of a four bar parallel linkage (50). The linkage (50) includes a pair of arms (52), pivotably coupled to the tube (46) by bolts or similar securement means. A steel shaft (56) is secured on one end to one of the arms (52) and on the other end through a hole in a steel ear (54) bolted to the bottom section (44) of the leg (42). Provided around the shaft (56) is a spring (58). In operation, the resilience of the spring (58) maintains a soil disrupter, such as a disc (60) at a predetermined orientation. If the disc (60) encounters a rock (not shown) or other obstruction, the obstruction forces the disc (60) to pivot upward, thereby pivoting the pivot arm (52), pushing the shaft (56) through the hole in the ear (54) and compressing the spring (58). Once the obstruction has passed, the resilience of the spring (58) forces the shaft (56) downward, thereby returning the disc (60) to its predetermined orientation.

The pivot arms (52) are pivotably coupled to a bar (62). Coupled to the end of the bar (62) is a support plate (64), preferably constructed of steel. Secured to the support plate (64) is a spring (66) that, in turn, is coupled to a curved steel bar (68) in a manner that biases the steel bar (68) toward a predetermined orientation. The spring (66) allows the steel bar (68) to divert from this parallel position to traverse rocks, cement, stumps or similar obstacles, without permanently bending or damaging the steel bar (68) or its orientation relative to the tube (46).

Also as shown in FIG. 6, coupled to the lower portion of the steel bar (68) is a knife (70) and an underground fluid dispenser (72), such as those known in the art. The underground fluid dispenser (72) includes a nitrogen delivery tube (74). The nitrogen delivery tube (74) may be constructed of any suitable material known in the art, and preferably has a 1.9 centimeter diameter with a wall thickness of 0.32 centimeters. The nitrogen delivery tube (74) is also secured to the support plate (64) to prevent the nitrogen delivery tube (74) from becoming inadvertently dislodged from the steel bar (68). The nitrogen delivery tube (74) is preferably in fluid communication with the fluid tank (14). (FIGS. 1 and 6). Preferably provided between the fluid tank (14) and nitrogen delivery tube (74) is a pump (76) and valve (78), electronically controlled from inside the cab (80) of the vehicle (12). (FIGS. 1, 2 and 6). The leg (42) is configured to allow the disc (60) and nitrogen delivery tube (74) to rotate relative to the frame (36) to prevent the disc (60) and nitrogen delivery tube (74) from binding as the vehicle (12) turns.

As shown in FIG. 1, a first leg (82), the frame (36), and a second leg (84) define an interior (86) having a first dimension between the soil (88) and lower face (90) of the frame (36) of between 1.1 and 1.5 meters, more preferably between 0.2 and 1.25 meters, and most preferably between 0.5 and 1.1 meters. The interior (86) preferably has a width ranging between 0.25 and 1.5 meters. The first leg (82), second leg (84), and frame (34) thereby define an area sufficient to accommodate the passage of plants (124) preferably approximately 1.5 meters tall, more preferably approximately 1.25 meters tall, and most preferably approximately 1.1 meters tall, without the plants (124) contacting the frame. The legs (40) are preferably fixed relative to one another, approximately 0.76 meters apart, but may be releasably mounted to the frame (36) to allow for infinite adjustment or variation, depending on the width of the crop rows (92). Although the height of the interior (86) may obviously fluctuate, depending on the condition of the soil (88), in the preferred embodiment, the discs (60) are provided with gauge wheels (94) to maintain the discs (60) cutting a predetermined depth into the soil (88) which, in the preferred embodiment is approximately ten centimeters. (FIGS. 1 and 6) The gauge wheels (94) are preferably injection molded plastic, secured to the discs (60) by bolts or similar securement means. The gauge wheels (94) preferably have a diameter of 40 centimeters to maintain the discs (60) cutting the soil (88) ten centimeters deep. Alternatively, the gauge wheels (94) may be separate tire and wheel assemblies (96) coupled to the frame (36) by a fork (98) in a manner such as that known in the art. If desired, both types of gauge wheels, the gauge wheels (94) secured to the discs (60) and the gauge wheels (94) having a tire and wheel assembly (96) may be used together or separately.

When it is desired to operate the fluid application system (10) of the present invention, the vehicle (12) is driven to the toolbar (22) to allow the toolbar (22) to be bolted to the vehicle (12) using a quick release or other attachment means such as those known in the art. The operator then raises the toolbar (22) sufficiently to prevent damage to the discs (60) as the toolbar (22) is transported.

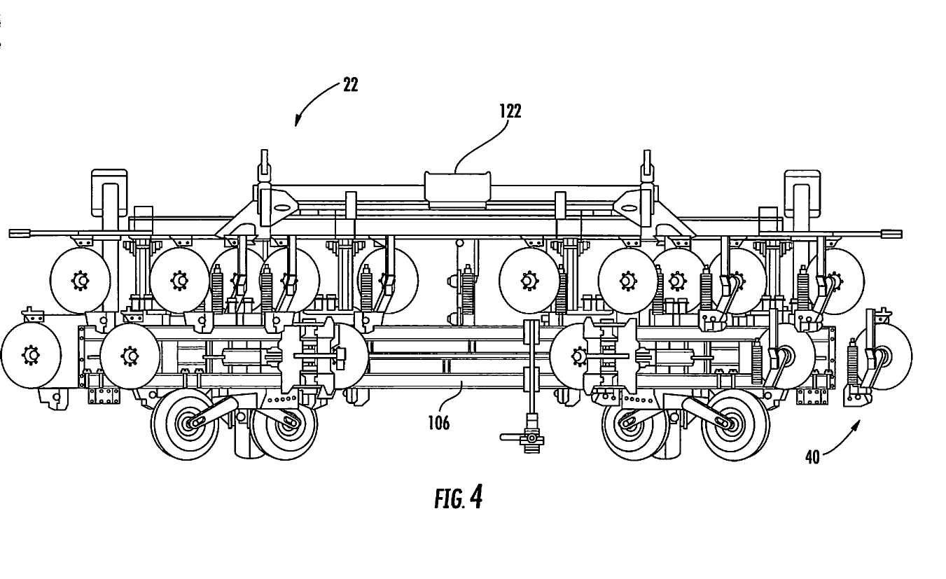

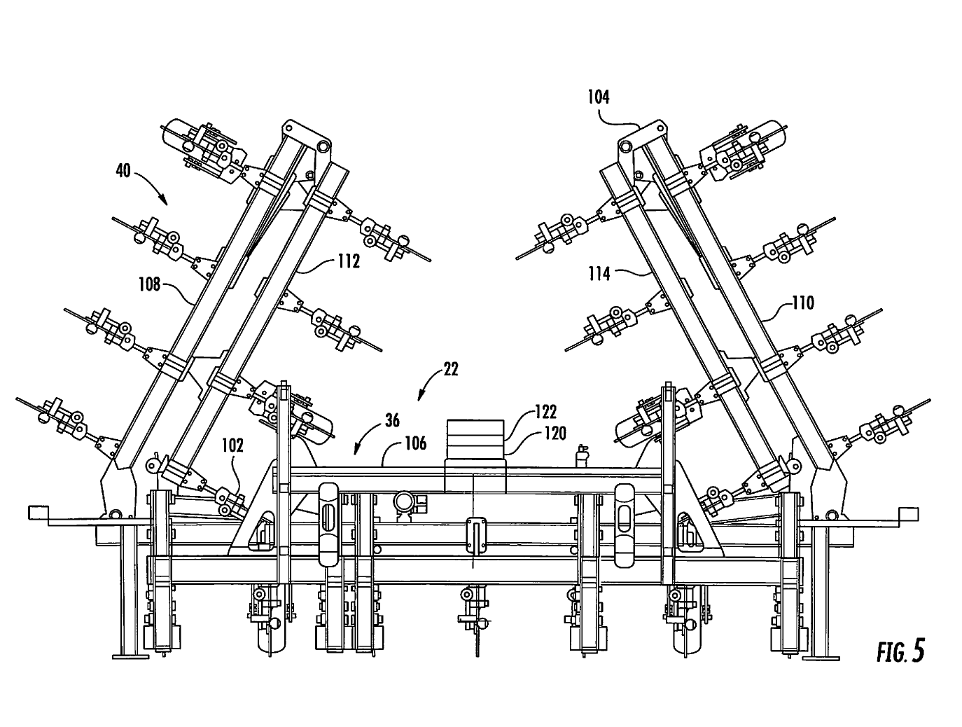

As shown in FIGS. 1, 2, 4 and 5, if it is desired to transport the fluid application system (10), the operator actuates the hydraulic motor (18) to actuate hydraulic pistons (102) provided on the toolbar (22). The hydraulic pistons (102) retract the bars (38) so as to cause them to pivot generally upward around a plurality of hinges (104) provided on the toolbar (22). The hydraulic pistons (102) continue to retract the bars (38) until the toolbar (22) takes the general configuration depicted in FIGS. 2, 4 and 5, having a width of approximately no more than 3.7 meters. As many jurisdictions have ordinances prohibiting vehicles wider than 3.7 meters from traveling on roadways without special permission, the retraction of the toolbar (22) to a width of 3.7 meters is particularly desirable when the fluid application system (10) is to be transported on public roadways. As shown in FIG. 5, when the toolbar (22) is in the transport position, bars (38) are folded upward and downward. In the transport position, the center bar (106) is positioned generally horizontally, with the legs (42) connected thereto directed generally downward. The wing bars (108) and (110) are positioned generally upward, and slightly inward, with the legs (42) connected thereto directed generally outward and slightly upward. The end bars (112) and (114) are positioned generally downward, and generally parallel to the wing bars (108) and (110) with the legs (42) connected thereto directed generally inward and slightly downward.

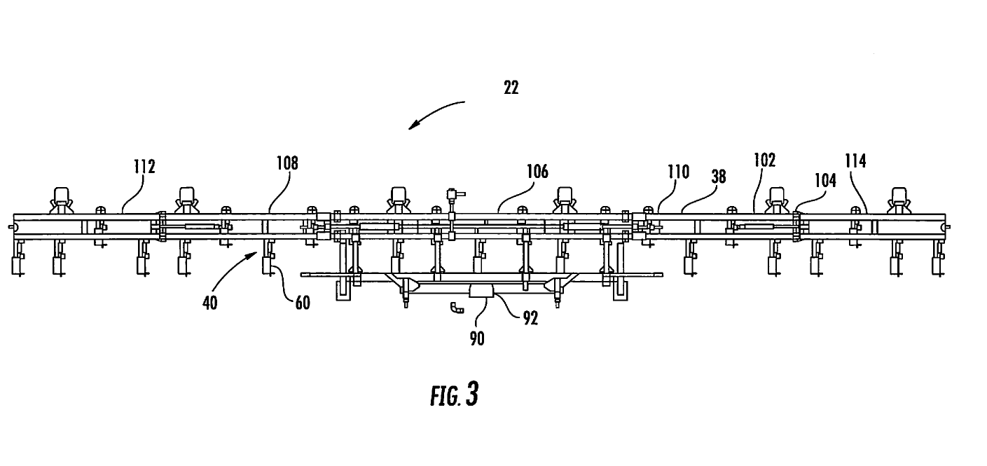

Once the vehicle (12) has transported the fluid application system (10) to the desired location for application, the operator actuates the hydraulic motor (18) to extend the hydraulic pistons (102) and straighten the toolbar (22) to the position shown in FIG. 3. Once the toolbar (22) has been straightened, the hydraulic motor (18) is actuated to engage the four four bar parallel linkage assemblies (24, 26, 28, and 30) to lower the toolbar (22) to a predetermined height, so that the discs (60) penetrate the soil (88) to the level of the gauge wheels (94).

The operator then actuates the vehicle (12) to move forward. The operator simultaneously activates the pump (76) and valve (78) to distribute fertilizer, such as liquid nitrogen (116) into the soil (88) through the nitrogen delivery tubes (68) into troughs (118) cut by the discs (60). (FIGS. 1, 2 and 6). Although the fluid application system (10) is preferably designed to dispense liquid nitrogen (116), the system (10) may be used to distribute any herbicide, pesticide, fungicide, fertilizer, or any other desired fluid in either gas or liquid form.

As shown in FIG. 5, provided on the frame (36) are a hydraulic control box (120) and electronic control system (122). Providing the hydraulic control box (120) and electronic control system (122) on the frame (36) allows all of the connections between the toolbar (22) and vehicle (12) to be made directly to the hydraulic control box (120), thereby expediting the attachment and detachment of the toolbar (22) relative to the vehicle (12). (FIGS. 1 and 5)

As shown in FIG. 1, the vehicle (12) drives the toolbar (22) across the soil (88), the discs (60) cut the soil (88) while the gauge wheels (94) prevent the discs (60) from cutting the soil (88) too deeply. Once the soil (88) has been cut, the steel bars (68) locate the nitrogen delivery tubes (74) within the resulting troughs (118) and the nitrogen delivery tubes (74) deliver a predetermined amount of liquid nitrogen (116) into the troughs (118). (FIGS. 1 and 6). The rotational coupling of the disc (60) and nitrogen delivery tube (74) relative to the frame (36), combined with the springs (58) and (66) allow the disc (60) and nitrogen delivery tube (74) to raise lower independently of other portions of the toolbar (22). This independence reduces breakage and maintenance associated with the disc (60) hitting rocks or other obstructions in the soil (88) or being twisted off as the vehicle (12) turns.

Although in the preferred embodiment the fluid application system (10) is provided with 23 legs (40) any desired number of legs (40) in any desired dimension or spacing may be provided. For example, the system (10) may preferably be provided with between 10 and 35 legs (40), more preferably between 15 and 30 legs (40), and most preferably between 20 and 25 legs (40). It is also anticipated that the legs (40) may be designed for manual or hydraulic positioning, both vertically and laterally, to accommodate plants in rows of varying dimensions and heights. It is desirable to maintain the lower face (90) of the frame (36) above the top of any plant (124) to prevent breakage or damage to the plants (124). Once the plants (124) grow sufficiently above the lower face (90) of the frame (36) so that the system (10) would cause damage to the plants (124) a taller application system such as that disclosed in U.S. Pat. No. 7,077,070 (which is incorporated herein by reference) may be used to avoid damage to the plants (124).

Once the appropriate amount of liquid nitrogen (116) has been applied to the soil (88), the hydraulic motor (18) is actuated to raise the toolbar (22) and actuate the hydraulic pistons (102) to collapse the toolbar (22) as shown in FIGS. 1 and 2, so that the fluid application system (10) may be transported along roadways.

Although the invention has been described with respect to a preferred embodiment thereof, it is to be understood that it is not to be so limited, since changes and modifications can be made therein that are within the full intended scope of this invention as defined by the appended claims. For example, it is anticipated that the fluid application system (10) may be constructed of any desired material, of any suitable dimensions or spacing, sufficient to accommodate a particular crop. It is additionally anticipated that the fluid application system (10) may be hydraulically, pneumatically, or mechanically actuated, and that the fluid application system (10) may be permanently fixed in position relative to the vehicle (12). It is also anticipated that the frame (36) may be provided in five, seven, nine or any desired number of sections having any desired number of legs (40).

What is claimed is:

1. A system for applying fluid below a surface of soil comprising:
a. a frame;
b. a first leg coupled to the frame;
c. a second leg coupled to the frame;
d. wherein the first leg, the second leg, and the frame define an area sufficient to accommodate the passage of plants at least approximately 0.5 meters in height;
e. a first soil disruptor coupled to the first leg;
f. a first underground fluid dispenser coupled to the first leg;
g. a second soil disrupter coupled to the second leg;
h. a second underground fluid dispenser coupled to the second leg; and
i. a gauge wheel coupled to the frame, wherein a bottom of the gauge wheel is located less than 1.5 meters from the frame.

2. The system according to claim 1, wherein the gauge wheel is of a construction whereby the bottom of the gauge wheel rides along a surface of soil.

3. The system according to claim 1, wherein the first leg, the second leg, and the frame define an area insufficient to accommodate the passage of a plant at least approximately 1.5 meters tall without the plant contacting the frame.

4. The system according to claim 1, wherein the first leg, the second leg, and the frame define an area insufficient to accommodate the passage of a plant at least approximately 1.25 meters tall without the plant contacting the frame.

5. The system according to claim 1, wherein the first leg, the second leg, and the frame define an area insufficient to accommodate the passage of a plant at least approximately 1.1 meters tall without the plant contacting the frame.

6. The system according to claim 1, wherein the first leg, the second leg, and the frame define an area insufficient to accommodate the passage of a plant at least approximately 1 meter tall without the plant contacting the frame.

7. The system according to claim 1, further comprising a fluid tank coupled to the first underground fluid dispenser.

8. The system according to claim 1, further comprising a pump coupled between the fluid tank and the first underground fluid dispenser

9. The system according to claim 1, further comprising a vehicle comprising
a. a chassis coupled to the frame;
b. a ground-engaging wheel coupled to the chassis; and
c. a motor drivably coupled to the ground-engaging wheel.

10. The system according to claim 9, wherein the vehicle has a ground clearance of at least approximately 1 meter.

11. The system according to claim 9, wherein the vehicle has a ground clearance of at least approximately 1.8 meters.

12. The system according to claim 9, wherein the ground engaging wheel is less than approximately 0.75 meters wide.

13. The system according to claim 9, wherein the ground engaging wheel is at least approximately 1 meter in diameter.

14. The system according to claim 1, wherein the gauge wheel is provide on the first soil disrupter.

15. The system according to claim 1, further comprising a bar connecting the gauge wheel to the frame.

16. A toolbar for applying fluid below a surface of soil comprising
a. a frame;
b. a plurality of legs depending from the frame in a manner that defines a plurality of passages of sufficient area to accommodate the passage of low row crops at least approximately 0.5 meters in height without the low row crops contacting the frame, and of insufficient area to accommodate the passage of high row crops at least approximately 1.5 meters in height without the low row crops contacting the frame
c. a plurality of soil disruptors coupled to the frame;
d. a plurality of underground fluid dispensers coupled to the frame; and
e. a plurality of gauge wheels coupled to the frame

17. The system according to claim 16, wherein the plurality of soil disrupters are coupled to the plurality of legs.

18. The system according to claim 16, further comprising a fluid tank coupled to the plurality of underground fluid dispensers.

19. The system according to claim 16, wherein the plurality of legs is at least sixteen legs.

20. A toolbar for applying fluid below a surface of soil comprising:
a. a frame having at least five sections hinged to one another;
b. a plurality of legs depending from the five sections;
c. wherein the plurality of legs comprises
i a first leg coupled to the frame;
ii a second leg coupled to the frame;
iii wherein the first leg, the second leg, and the frame define an area sufficient to accommodate the passage of plants at least approximately 0.5 meters in height;
iv a first soil disruptor coupled to the first leg;
v a first underground fluid dispenser coupled to the first leg;
d. wherein a first section of the at least five sections is generally horizontal;
e. wherein at least two sections of the at least five sections are oriented generally upward;
f. wherein at least two sections of the at least five sections are oriented generally downward; and
g. At least twenty underground fluid dispensers coupled to the at least twenty legs.

21. A system for applying fluid below a surface of soil comprising:
j. a frame;
k. a first leg coupled to the frame;
l. a second leg coupled to the frame;
m. wherein the first leg, the second leg, and the frame define an area sufficient to accommodate the passage of pants at least approximately 0.5 meters in height;
n. a first soil disruptor coupled to the first leg;
o. a first underground fluid dispenser coupled to the first leg;
p. a second soil disrupter coupled to the second leg;
q. a second underground fluid dispenser coupled to the second leg; and
r. a gauge wheel coupled to the frame, wherein a bottom of the gauge wheel is located less than 1.5 meters from the frame.
